(19) United States
(12) Patent Application Publication
(10) Pub. No.: US 2009/0058644 A1
(43) Pub. Date: Mar. 5, 2009

(54) SYSTEM AND METHOD FOR REDUCING INVENTORY SHRINK

(76) Inventors: John R. French, San Diego, CA (US); Robert M. Harling, Valley Center, CA (US)

Correspondence Address: NYDEGGER & ASSOCIATES, 348 OLIVE STREET, SAN DIEGO, CA, 92103, US

(21) Appl. No.: 11/849,074

(22) Filed: Aug. 31, 2007

(51) Int. Cl. G08B 13/14

(52) U.S. Cl. 340/568.2

(57) ABSTRACT

A merchandise monitoring system includes a weight sensor mounted on a pad for supporting merchandise. Further, a controller is electronically connected to the weight sensor for measuring weight decrements as merchandise is removed from the pad. Also, an enunciator is mounted on the controller to create an alarm when a cumulative weight decrement exceeds a predetermined value within a pre-selected time duration. Accordingly, a mobile corresponder is carried by store personnel for receiving the alarm. To provide oversight for system operation, the controller is electrically connected to a monitor.

### FIELD OF THE INVENTION

The present invention pertains generally to anti-theft systems. More particularly, the present invention pertains to anti-theft systems that are used to prevent theft of merchandise displayed at retail establishments. The present invention is particularly, but not exclusively, useful as a system and method for monitoring the removal of merchandise from shelves in retail establishments for the purpose of preventing the theft of such merchandise.

### BACKGROUND OF THE INVENTION

Shoplifting continues to be a major issue for retailers. Annually, more than $13 billion worth of goods are stolen from retailers in the U.S., i.e., more than $25 million worth of goods per day. In order to reduce losses, retailers have taken numerous actions to reduce shoplifting. For instance, magnetic tags are often used on clothing items to prevent removal of the clothing from the store without approval of store personnel. Also, video surveillance systems are frequently used to identify suspicious behavior by customers in stores. While these methods help to combat shoplifting, they are labor-intensive and cost-prohibitive for certain goods, and may be inapplicable for other goods.

In order to maximize the effects of theft deterrence efforts, certain goods may be identified as being particularly attractive for shoplifters. Further, certain shopping behavior may be identified as indicating the occurrence of shoplifting. With this knowledge, profiles can be created for some shoplifting activity. While not all theft can be characterized by a profile, a significant amount can be. For instance, the removal of large amounts of valuable items from store shelves or displays in a short period of time, may indicate a high likelihood of shoplifting. Such theft is a cause of concern among retailers and would be reduced by a system which can monitor and indicate potential occurrences of shoplifting.

In light of the above, it is an object of the present invention to provide a system and method for monitoring, in real-time, the removal of selected merchandise from shelves in retail establishments. Further, it is an object of the present invention to provide a system and method for immediately informing personnel of the removal of selected merchandise from shelves in order to prevent theft of such merchandise. Another object of the present invention is to provide a theft prevention system that immediately alerts a store manager, or security personnel, that certain retail goods have been removed from a shelf in the retail establishment. Still another object of the present invention is to provide a monitoring system that records instances of potential theft for use in store planning and logistics. It is another object of the present invention to provide a merchandise monitoring method and system that is easy to implement, is cost effective and is simple to use.

### SUMMARY OF THE INVENTION

The present invention is directed to a system for monitoring the removal of merchandise from shelves in retail establishments. More specifically, the system is designed to create an alarm whenever a predetermined amount or weight of merchandise is removed within a short period of time from a shelf.

Structurally, the monitoring system of the present invention includes a pad positioned on a shelf for supporting merchandise. Also, the system includes a weight sensor that is mounted on the pad. In a preferred embodiment of the present invention, the pad is made of an elastomeric material and the weight sensor is embedded in the pad. In more detail, the weight sensor will preferably comprise an array of elements that include piezoelectric crystals. Further, the sensors will be dispersed in a pattern on the pad. In an alternate embodiment of the present invention, the weight sensor can be structurally incorporated into the shelf.

In the monitoring system of the present invention, a controller is electronically connected to the weight sensor. Thus, the controller can continually assess the weight of the merchandise being supported on the pad and, more specifically, measure weight decrements as merchandise is removed from the pad. Further, an enunciator is connected to the controller. For purposes of the present invention, the enunciator creates an alarm whenever a cumulative weight decrement exceeds a predetermined value within a pre-selected time duration. As a result, the enunciator allows for real-time notification of the removal of goods and for an instantaneous response. While the alarm may be a generally-directed audible siren, in certain embodiments the alarm comprises a summons or silent page to a specific person or group of people. Specifically, the enunciator may include a transmitter for communicating electronically with a mobile corresponder carried by a store manager or other personnel. Preferably, such communication is via radio frequency. Further, the mobile corresponder may be incorporated into another electronic device such as a walkie-talkie or mobile phone.

In order to provide oversight for operation of the system, a monitor is electrically connected to the controller. Further, the monitor, or controller, may allow selective adjustment of a maximum predetermined weight decrement value, and adjustment of the associated pre-selected time duration.

For the operation of the system of the present invention, the pad is installed on a shelf and merchandise is stacked on the pad. After the merchandise has been stacked, the weight sensor measures, and the controller assesses, the weight of goods on the pad. Whenever a cumulative weight decrement is detected, within the pre-selected time duration, and it is beyond the predetermined value, the enunciator creates an alarm. Thus, whenever an inordinate amount of goods have been removed from the shelf, the alarm will indicate that a potential theft is occurring. As envisioned for the present invention, a plurality of pads can be employed at a retail establishment, on a respective number of shelves.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a retail establishment equipped with an embodiment of the system for monitoring the removal of merchandise from shelves in accordance with the present invention; and

FIG. 2 is a schematic drawing of the electronic components of the monitoring system in accordance with the present invention.

### DESCRIPTION OF THE PREFERRED EMBODIMENTS

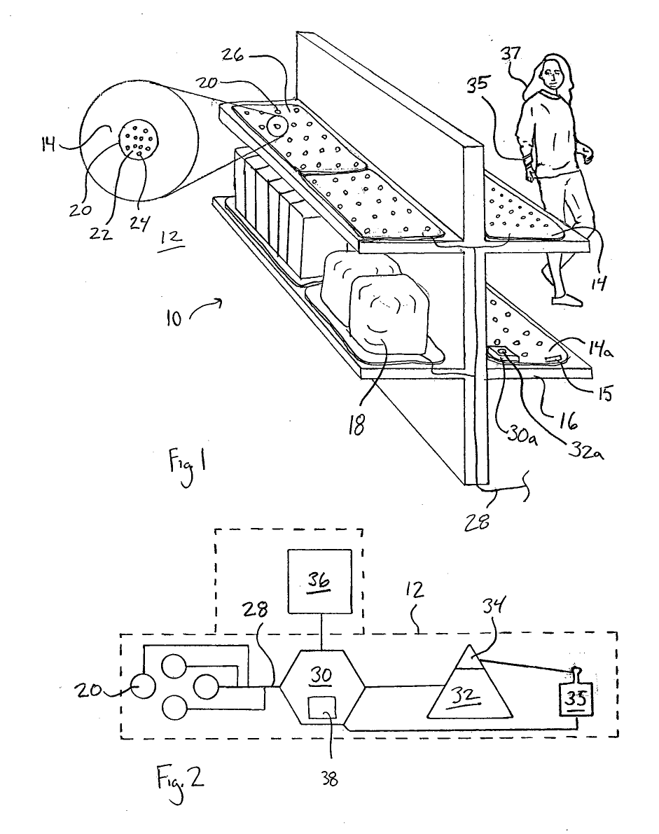

Referring initially to FIG. 1, a system in accordance with the present invention is shown and is generally designated 10. As shown, the system 10 is employed in a retail establishment 12. Specifically, the system 10 includes a plurality of pads 14 that are identified by tags 15 and mounted on shelves 16 within the establishment 12 to hold various objects 18 for sale. Preferably, the pads 14 are made from elastomeric material. Further, scales or weight sensors 20 are embedded within the elastomeric material of each pad 14. More specifically, each weight sensor 20 comprises an array 22 of elements 24, such as piezoelectric crystals, for measuring weight. As further shown in FIG. 1, the sensors 20 can be provided in a desired pattern 26 on the pads 14. Regardless of the pattern 26 utilized, the elements 24 of the weight sensors 20 are electrically connected to a lead 28.

In FIG. 2, the remaining components of the system 10 are illustrated. As shown, the lead 28 from the weight sensors 20 is connected to a controller 30. Further, the controller 30 is electronically connected to an enunciator 32. As shown, the enunciator 32 includes an alarm transmitter 34. For the present invention, an alarm from the enunciator 32 is transmitted, preferably via radio frequency, to a mobile corresponder 35. As shown, the corresponder 35 is in communication with the controller 30 and is worn or carried by store personnel 37 (see FIG. 1). Also, the controller 30 is connected via radio frequency to a monitor 36 that provides oversight for operation of the system 10. In FIG. 2, it can be seen that the sensors 20, controller 30, enunciator 32, and corresponder 35 are positioned within the retail establishment 12 while the monitor 36 may be located in the retail establishment 12 or off-site.

In order to monitor the removal of merchandise objects 18, the objects 18 are positioned on the pads 14 on the shelves 16. Accordingly, the weight sensors 20 assess the weights of the objects 18 on the pads 14. For operation of the system 10, the weights of the objects 18 are continuously communicated from the sensors 20 to the controller 30. As a result, when an object 18 is removed from a shelf 16, the sensors 20 immediately communicate the new weight to the controller 30 and the controller 30 measures the resulting weight decrement. When the weight decrement exceeds a predetermined value within a pre-selected time duration, the controller 30 instructs the enunciator 32 to activate the alarm transmitter 34. As a result, the corresponder 35 notifies the store personnel 37 of the possible attempted theft. At the same time, the monitor 36 may record the weight decrements and instances of alarm, or allow a supervisor to observe the operation of the system 10. In this manner, store personnel 37 will be informed in real-time when a selected amount of merchandise 18 is removed from a shelf 16. Further, the monitor 36 may include or be integrated into a network accessible by store management or outside security advisors to examine each activation of the alarm transmitter 34 to review the occurrences of theft to determine possible patterns or profiles for theft.

As shown in FIG. 1, each pad 14a may be equipped with a controller 30a and enunciator 32a. Alternatively, the pads 14 on a common shelf 16, in a common area, or in a retail establishment 12 are all connected to a single controller 30 and enunciator 32. In any case, when an alarm is sent to the corresponder 35 from an enunciator 32, the identity of the pad 14 that experienced the possible theft is communicated to the corresponder 35. As a result, the store personnel 37 may arrive at the location of the possible theft as soon as possible.

In practice, the system 10 will be used with merchandise 18 having widely varying weights. For instance, a single unit of baby formula may be significantly heavier than dry goods. In order to allow use of the system 10 with merchandise having different weights, the controller 30 is provided with a data input 38. Specifically, the input 38 may be programmed with a specific predetermined value (e.g., eight ounces, one pound, or two pounds) and specific pre-selected time duration (e.g., less than five seconds, ten seconds, one minute or five minutes) for each sensor 20, for each pad 14, for each shelf 16, or for an entire aisle. In this manner, the predetermined value and pre-selected time duration may be selectively adjusted. In order to minimize labor costs, the controller 30 may be programmed with predetermined values and pre-selected time duration for each type of objects 18 for sale. As a result, an SKU can be quickly entered into the data input 38 for a location, and the appropriate predetermined value and pre-selected time duration can be automatically applied to that location. For instance, for systems 10 incorporating one controller 30 for a large number of pads 14, the identity of the pad 14 can be entered followed by the SKU of the merchandise 18 it holds.

After the system 10 has identified a possible theft based on the removal of a weight of objects 18 above the predetermined value in a period of time less than the pre-selected duration, the system 10 is reset. Specifically, the controller 30 automatically resets the pad 14 and/or sensors 20 that registered the possible theft.

While the particular System and Method for Reducing Inventory Shrink as herein shown and disclosed in detail is fully capable of obtaining the objects and providing the advantages herein before stated, it is to be understood that it is merely illustrative of presently preferred embodiments of the invention and that no limitations are intended to the details of construction or design herein shown other than as described in the appended claims.

What is claimed is:

1. A system which comprises:
a pad for supporting a plurality of objects thereon;
a weight sensor mounted on the pad;
a controller electronically connected to the weight sensor for measuring weight decrements in real-time as objects are removed from the pad;
an enunciator connected to the controller to immediately create an alarm when a cumulative weight decrement exceeds a predetermined value within a pre-selected time duration;
a mobile corresponder for receiving the alarm from the enunciator and for informing personnel that a cumulative weight decrement exceeds the predetermined value within the pre-selected time duration; and
a monitor electrically connected to the controller to provide oversight for system operation.

2. A system as recited in claim 1 further comprising a means mounted on the controller to selectively adjust the predetermined value for a cumulative weight decrement.

3. A system as recited in claim 1 wherein the pad is positioned on a merchandise shelf of a retail establishment.

4. A system as recited in claim 3 further comprising a plurality of pads.

5. A system as recited in claim 1 wherein the weight sensor is an array of elements.

6. A system as recited in claim 5 wherein each element in the array includes a piezoelectric crystal.

7. A system as recited in claim 1 wherein the pre-selected time duration is less than one minute.

8. A system as recited in claim 1 wherein the pad is made of an elastomeric material and the sensor is embedded in the pad.

9. A system as recited in claim 1 wherein the controller is located on the premises of a retail establishment, and the monitor is located off-site.

10. A system for monitoring the removal of objects from a merchandise shelf in a retail establishment which comprises:
a scale mounted on the shelf for assessing a collective weight of the objects displayed on the shelf;
a means for determining a significant event, wherein the significant event is characterized by a predetermined cumulative weight decrement within a pre-selected time duration;
an alarm means connected to the determining means to create an alarm in response to a significant event; and
an electronic means for receiving the alarm to notify personnel that a significant event has occurred.

11. A system as recited in claim 10 further comprising a pad for supporting the objects displayed on the shelf, and wherein the scale is mounted on the pad.

12. A system as recited in claim 10 further comprising a monitor electrically connected to the determining means and to the alarm means to provide oversight for system operation.

13. A system as recited in claim 12 wherein the determining means is located on the premises of a retail establishment, and the monitor is located off-site.

14. A system as recited in claim 10 further comprising a means for selectively adjusting the predetermined cumulative weight decrement.

15. A system as recited in claim 14 further comprising a means for selectively adjusting the pre-selected time duration.

16. A method for monitoring the removal of objects from a merchandise shelf in a retail establishment which comprises the steps of:
providing a monitoring system including a pad on the shelf for supporting the objects thereon, a weight sensor mounted on the pad, a controller electronically connected to the weight sensor for measuring weight decrements as objects are removed from the pad, an enunciator mounted on the controller to create an alarm when a cumulative weight decrement exceeds a predetermined value within a pre-selected time duration, a mobile corresponder for receiving the alarm from the enunciator, and a monitor electrically connected to the controller to provide oversight for system operation;
positioning the objects on the weight sensor on the pad;
measuring weight decrements as objects are removed from the pad;
determining whether the cumulative weight decrement exceeds the predetermined value within the pre-selected time duration;
creating an alarm with the enunciator when the cumulative weight decrement exceeds the predetermined value within the pre-selected time duration; and
communicating the alarm from the enunciator to the mobile corresponder to inform personnel that a cumulative weight decrement exceeds the predetermined value within the pre-selected time duration.

17. A method as recited in claim 16 wherein the monitoring system further includes a means mounted on the controller to selectively adjust the predetermined value for a cumulative weight decrement, and wherein the method further comprises the step of selectively adjusting the predetermined value for a cumulative weight decrement.

18. A method as recited in claim 17 wherein the monitoring system further includes a means mounted on the controller to selectively adjust the pre-selected time duration, and wherein the method further comprises the step of selectively adjusting the pre-selected time duration.

19. A method as recited in claim 16 wherein the weight sensor is an array of piezoelectric crystals.

20. A method as recited in claim 16 wherein the controller is located on the premises of the retail establishment, and the monitor is located off-site.
